(19) United States
(12) Patent Application Publication
(10) Pub. No.: US 2021/0260920 A1
(43) Pub. Date: Aug. 26, 2021

(54) BRAKING CASTER

(71) Applicant: Zenithen USA LLC d/b/a Z Company, Upland, CA (US)

(72) Inventors: Andrew David Frankel, Yorba Linda, CA (US); Shi-Ping Zheng, Fuzhou (CN); Tian-Xia Zheng, Fuzhou, Fujian (CN)

(73) Assignee: Zenithen USA LLC, d/b/a Z Company

(21) Appl. No.: 16/798,573

(22) Filed: Feb. 24, 2020

(30) Foreign Application Priority Data
Feb. 21, 2020 (CN) 202020192068.5

(51) Int. Cl. B60B 33/00

(52) U.S. Cl. CPC B60B 33/0084; B60B 33/0039

(57) ABSTRACT

A braking caster is provided that includes casters, a frame, braking plates, and springs. One end of a spring is hung on to the spring hook of the brake plate, and the other end is hung on to the frame. As the unstable status is caused by the spring swinging with the brake plate to the position of the rivet, the manually driven brake handle bypasses the unstable status, and can achieve stable braking and released statuses.

### BACKGROUND OF THE INVENTION

### Field of the Invention

This invention belongs to the field of casters for luggage and push carts, and particularly involves a type of braking caster. Specifically, it utilizes brake plates and spring action to stably maintain a braking or released condition.

### Technical Background

China patent application CN201210359173.3 discloses a type of braking caster. It includes a caster frame and turnable wheels on the caster frame. The wheels have wheel clutches. The frame has movable brake plates, and the brake plates have brake clutches. When the brake plates move back and forth, they can utilize the brake clutches and the wheel clutches to brake or release the wheels. There are elastic resets for the brake plates between the brake plates and the caster frame. Brake pedals are hinged to the caster frame. A pushing device is located on each hinge axis and can be driven by the hinge axis to push the brake plates back and forth. The pushing device includes a kicker that can push the brake plates, and a drive mechanism on the hinge axis that can turn the kicker in one direction as driven by the spinning the hinge axis. The braking caster achieves reliable braking through the design of the clutch chuck. However, the back and forth movement of the brake plates needs to be driven by the brake pedals, and each needs to work together with the pushing device and the drive mechanism. The overall structure is complicated and there are many associated mechanisms, and it is difficult to be applied in confined spaces.

An objective of this new invention is to overcome the inadequacy of existing technology and to simplify the braking solution.

### SUMMARY OF THE INVENTION

An objective of this invention is to provide a type of braking caster that directly utilizes braking plates and spring action to form stable conditions of braking and releasing.

The invention is achieved in the following ways:

A braking caster that includes caster, frame, braking plates, and springs. The casters are hinged to the frame through wheel axles. Braking is achieved by braking plates on the casters.

The characteristics include: Each brake plate has rivet hole, spring hook, brake hook, and brake handle. The brake plate utilizes the rivet hole to connect to the frame in a movable way. One end of the spring is hung on to the spring hook of the brake plate, and the other end is hung on to the frame or hinge. As the brake plate swings, the swing radius of the spring hook is smaller than the swing radius of the spring, and when the spring swings according to the position of the rivet hole, the spring is extended to the longest and least stable status. Braking status is achieved when it swings to one side, and release status is achieved when it swings to the other side. In the braking status, the brake plate is under the spring action of the spring, and the brake hook is inserted into the brake gear socket that moves with the caster.

The brake plate is formed from punch-sheared steel plate. It bends inwardly to form the spring hook and the brake hook, and bends outward to form the brake handle. The brake handle rests on the frame to form a lead limit. The frame is formed from punch-sheared steel plate and bent to form a U-shaped structure. The ends of the two U-shaped arms have symmetrical axle punched holes. The middle of one of the U-shaped arm has rivet punched hole, and a spring hanging hook is bent inwardly at the top part of the arm.

The brake gear is directly formed on one side of the caster. The brake plate and spring are located between the caster and one U-shaped arm of the frame.

The brake gear is connected to the axle hole of the caster through the spline shaft to form a linkage. The brake plate and spring are located between the caster and one U-shaped arm of the frame.

The brake gear is locked to the wheel axle on one side of the caster to form a linkage. The wheel axle is positioned to the punched hole of the two frame wheels through a bearing or slide bushing. The brake plate and spring are located on the U-shaped arm of the frame that is on the same side as the brake gear.

This invention is characterized in part by its smart concept, logical design, minimum number of parts, and simple and reliable operations for braking and releasing. It adequately utilizes the difference in radius between the pivot point of the spring and the spring swing, and the unstable status caused by the spring swinging with the brake plate to the position of the rivet. The manually driven brake handle bypasses the unstable status, and can achieve stable braking and released statuses without the need of extra parts or coordination.

### BRIEF DESCRIPTION OF THE DRAWINGS

FIG. 1 is a diagram of a braking caster.

FIG. 2 is a frontal view of a braking caster.

FIG. 3 is a decomposition view of a braking caster.

FIG. 4 is a diagram of a simplified caster in braking status.

FIG. 5 is a diagram of a simplified caster in released status.

FIG. 6 is a diagram of a brake plate.

Similar reference characters denote corresponding features consistently throughout the attached drawings. Namely, in the drawings the following reference numbers refer to the following part:
1—caster
11—wheel axle
12—axle sleeve
13—brake gear
2—frame
21—U-shaped arm
22—wheel axle punched hole
23—rivet punched hole
24—spring hanging hook
3—brake plate
31—rivet hole
32—spring hook
33—brake hook
34—brake handle
4—spring
5—rivet

### DETAILED DESCRIPTION OF THE PREFERRED EMBODIMENT(S)

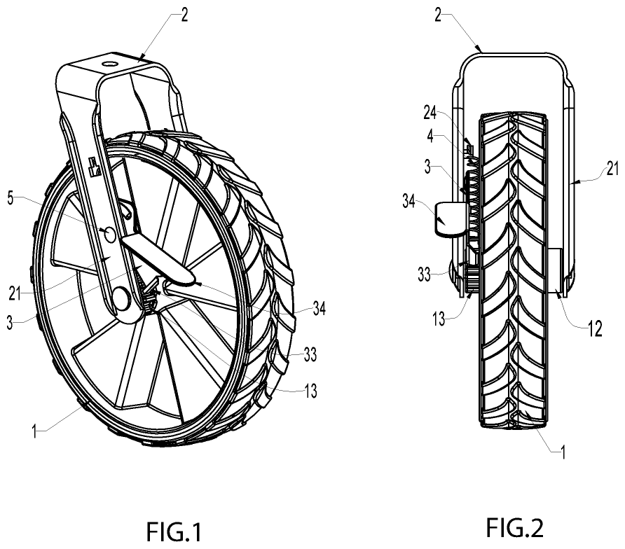

Referring to FIGS. 1-3, a type of braking caster is shown that includes casters 1, frame 2, braking plates 3, and springs 4. The casters 1 are hinged to the frame 11 through the wheel axles 11. Braking of the casters is achieved by braking plates 3. In this example, the caster 11 and wheel axle 11 have a separate structure. The caster 1 can freely rotate relative to the wheel axle 11. There can be a bearing or axle sleeve 12 between them to reduce abrasion and decrease friction. Wheel axle 11 can be directly locked to the frame 2 or directly riveted. To achieve braking, one side of a caster 1 has a brake gear 13 or the axle sleeve can have a brake gear 13 linked to the caster 1 by the axle sleeve. In other words, linkage is achieved by the coordination of the spline and top pin. Depending on the situation, the frame 2 can be formed from plastic, or in this example, the frame 2 is formed from punch-sheared steel plate and bent to form a U-shaped structure. The ends of the two U-shaped arms have symmetrical axle punched holes 22. The middle of one of the U-shaped arm 21 has a rivet punched hole 23, and a spring hanging hook 24 is bent inward at the top part of the arm.

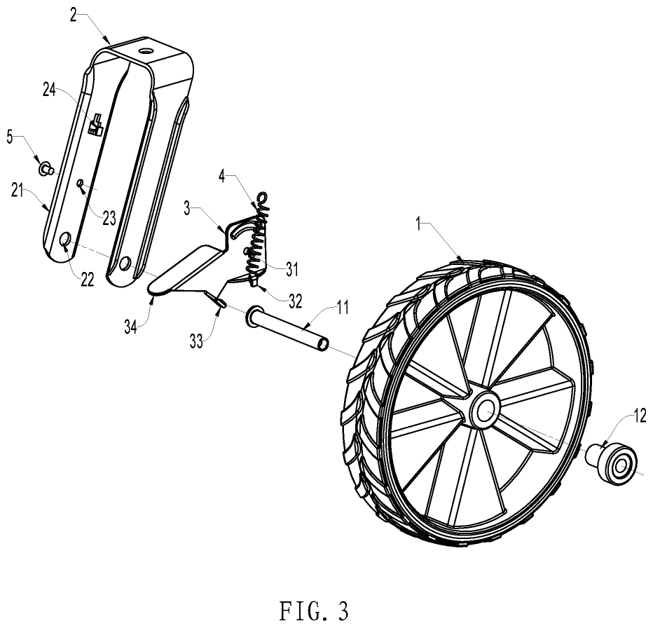

Combining the devices of FIG. 3 and FIG. 6, each brake plate 3 has rivet hole 31, spring hook 32, brake hook 33, and brake handle 34. The brake plate 3 utilizes the rivet hole 31 to connect to the frame 2 in a movable way. In other words, the rivet 5 goes through the rivet punched hole 23 on the frame and the rivet hole 31 on the brake plate to form a turnable riveting. In addition, the brake plate 3 is formed from punch-sheared steel plate. It bends inwardly to form the spring hook 32 and the brake hook 33, and bends outwardly to form the brake handle 34. This keeps the main body of the brake plate 3 fastened to the frame 2, and the two bending parts can function separately, thus reinforcing the main body.

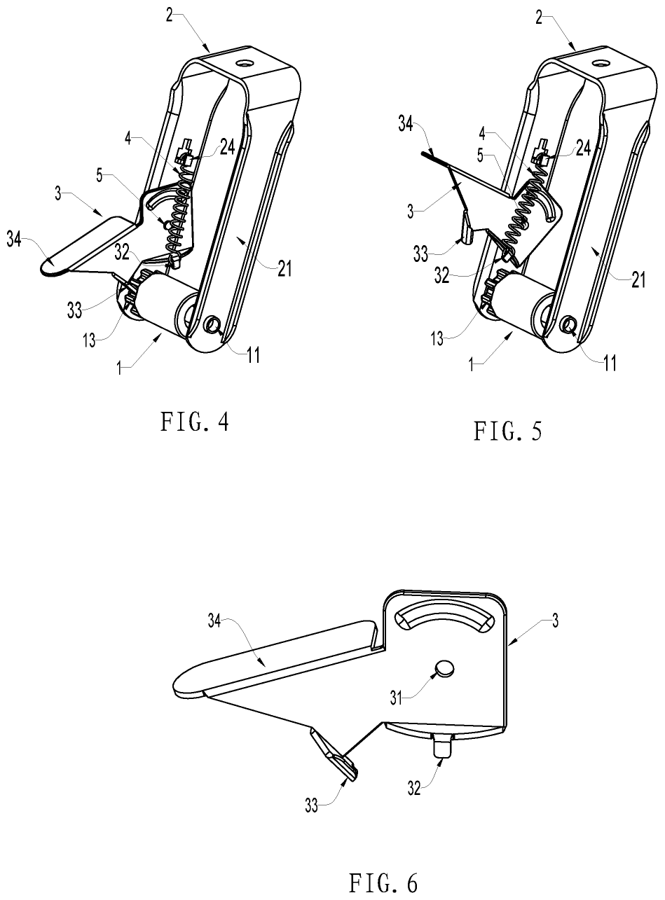

Combining now FIG. 3, FIG. 4, and FIG. 5, FIGS. 4 and 5 simplify the caster 1, and the radius is shrunk to show the structure of the brake gear 13. One end of the spring 4 is hung onto the spring hook 32 of the brake plate, and the other end is hung on to the spring hook 24 on the frame. As the brake plate 3 swings, the swing radius of the spring hook 32 is smaller than the swing radius of the spring 4, and when the spring 4 swings accordingly to the position of the rivet hole, the spring 4 is extended to the longest and least stable status, and slightly swings to the two sides. It enters a stable status under the spring action. Based on this characteristic, braking status is achieved when it swings to one side, and the released status is achieved when it swings to the other side. In braking status, the brake plate 3 is under the spring action of the spring 4, and the brake hook 33 is inserted into the brake gear 13 socket that moves with the caster. This achieves reliable braking. When the spring force is overcome manually to swing the brake handle 34 to cross over the unstable status of the rivet position, it will immediately swing toward the braking direction under the same spring action. In addition, the brake handle 34 bends outwardly and rests on the U-shaped arm 21 of the frame to form a lead limit for the released status. Therefore, the best distribution positions for the brake hook 33 and brake handle 34 on the brake plate 3 are on the same side as and aligned with rivet hole 31 and spring hook 32. The lead limit can utilize the brake hook 33 and brake handle 34 without the need for extra design. Certainly, brake hook 33 and brake handle 34 can also be distributed on two sides of the alignment. In such a structure, a lead limit needs to be designed for the releasing direction to prevent the brake plate from being too flexible in this direction and affect the spinning of the caster.

For Spring 4, in addition to the installation in the above example, one end can also be directly hung on to the wheel axle. This way the spring hook 32 on the brake plate must be positioned on the top edge of the brake plate, so that the spring 4 crosses over the position of the rivet, while the other end is hung on to the spring hook 32 on the top edge of the brake plate. This can also achieve the stable statuses for braking and releasing.

To summarize, the key of this application is the coordinating structure of the brake plate 3 and the spring 4. It utilizes the unstable status during the swinging of the brake plate 3 and the double stable status after it shifts to the two sides to achieve braking or releasing, and it only requires the operation of brake plate 3 to swing and cross-over the spring 4 and to extend to the longest unstable status, such that braking or releasing can be reliably maintained under spring action. This can significantly simplify the configuration of the braking mechanism, and the configuration of the brake gear 13 can have the following three typical structures according to specific products:

1: The brake gear 13 is directly formed on one side of the caster 1. The brake plate 3 and spring 4 are located between the caster 1 and one U-shaped arm 21 of the frame. This structure is compact and protective.

2: The brake gear 13 is connect to the axle hole of the caster 1 through the spline shaft to form a linkage. In other words, the brake gear 13 is formed on the axle sleeve 12. The brake plate 3 and spring 4 are located between the caster 1 and one U-shaped arm 21 of the frame. This design is more flexible than the previous one, and different materials can be used to ensure the required functionality is achieved.

The above two types are suitable for omni directional wheels to achieve independent braking.

3: The brake gear 13 is locked to the wheel axle 11 on one side of the caster to form a linkage. The wheel axle 11 is positioned to the punched hole 22 of the two frame wheels through a bearing or slide bushing. In other words, the wheel axle 11 and the caster 1 have a synchronous structure, and the brake gear 13 is locked on to the wheel axle 11 so that the position range of the brake design is greater, and is especially suitable for two-wheeled push carts as it only requires one braking action. The brake plate 3 and spring 4 are located on the U-shaped arm 21 of the frame that is on the same side as the brake gear 13. In this structure, the frame 2 or the U-shaped arm 21 can be understood as a part of the cart frame that is fixed with the frame 2.

I claim:

1. A braking caster that includes caster, frame, braking plates, and springs, comprising:
the casters are hinged to the frame through wheel axles;
braking is achieved by braking plates on the casters;
each brake plate has rivet hole, spring hook, brake hook, and brake handle;
the brake plate utilizes the rivet hole to connect to the frame in a movable way;
one end of the spring is hung on to the spring hook of the brake plate, and the other end is hung on to the frame or hinge;
as the brake plate swings, the swing radius of the spring hook is smaller than the swing radius of the spring, and when the spring swings accordingly to the position of the rivet hole, the spring is extended to the longest and least stable status;
braking status is achieved when it swings to one side, and released status is achieved when it swings to the other side;
when when in braking status, the brake plate is under the spring action of the spring, and the brake hook is inserted into the brake gear socket that moves with the caster.

2. The braking caster of claim 1, wherein:
the brake plate is formed with punch-sheared steel plate and bends inwardly to form the spring hook and the brake hook, and bends outwardly to form the brake handle;
the brake handle rests on the frame to form a lead limit;
the frame is formed with punch-sheared steel plate and bent to form a U-shaped structure;
The ends of the two U-shaped arms have symmetrical axle punched holes; and the middle of one of the U-shaped arm has rivet punched hole, and a spring hanging hook is bent inward at the top part of the arm.

3. The braking caster of claim 1, wherein the brake gear is directly formed on one side of the caster and the brake plate and spring are located between the caster and one U-shaped arm of the frame.

4. The braking caster of claim 1, wherein the brake gear is connect to the axle hole of the caster through the spline shaft to form a linkage, and the brake plate and spring are located between the caster and one U-shaped arm of the frame.

5. The braking caster of claim 1, wherein the brake gear is locked to the wheel axle on one side of the caster to form a linkage;
the wheel axle is positioned to the punched hole of the two frame wheels through a bearing or slide bushing; and
the brake plate and spring are located on the U-shaped arm of the frame that is on the same side as the brake gear.
